(19) United States
(12) Patent Application Publication
(10) Pub. No.: US 2006/0138169 A1
(43) Pub. Date: Jun. 29, 2006

(54) Multiple chamber container

(76) Inventor: Phil Cafferty, Chesterton, IN (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/284,435

(22) Filed: Nov. 21, 2005

Related U.S. Application Data
(60) Provisional application No. 60/629,961, filed on Nov. 22, 2004.

(51) Int. Cl. B67D 5/56

(52) U.S. Cl. 222/129

(57) ABSTRACT

A multiple chamber container is provided that has a first chamber and a second chamber separated by a divider positioned within an outer surrounding wall. An opening for the first chamber is provided on one end of the container, and an opening for the second chamber is provided on an opposite end of the container. The openings can each be selectively closed, such as with a removable cap.

### FIELD

The invention pertains to a container, and in particular to a flexible container having multiple chambers with openings disposed on opposite ends of the container.

### BACKGROUND

Containers are used to contain a variety of products, such as foods and beverages, soaps and shampoos, and cleaning fluids. Configuring the external profile of containers to allow the containers to stand-up on their own allows for convenient storage. For example, a stand-up container can be placed on a shower shelf, on a bathtub ledge, and on a refrigerator shelf without requiring any additional support structure. However, stand-up containers often have just a single chamber capable of containing only one product. Thus, in the case of a product that is commonly used with another related product, two different containers are required. This can make it difficult for product manufacturers and resellers to market and sell related products together, and is inconvenient for the consumer.

Containers have been provided having dual chambers. Each of the prior art containers have disadvantages, however. For instance, providing a single, shared opening for multiple chambers, or openings for each of multiple chambers on the same side of the container can cause confusion. A user of a container may believe they are getting one type of contents when they really are getting another type of contents due to the close proximity of the container openings. For example, U.S. Pat. No. 4,193,521 discloses a dual chamber container having a divider wall between the chambers extending parallel to the length of the container. However, the opening of the first chamber and the opening of the second chamber are both on the same side of the container. U.S. Pat. No. 5,529,195 discloses a container having a pair of chambers separated by a dividing wall. However, both container chambers share a common opening disposed on just one end of the container.

Other dual chamber containers made of rigid materials such as steel or aluminum have been provided, but such containers are generally limited for use with liquid products that can be poured by force of gravity. Such containers are not useful as squeeze containers.

### SUMMARY

A multiple chamber container is provided having a first chamber and a second chamber. The first and second chambers of the dual chamber container are separated from each other by a divider. The container may comprise an outer surrounding wall extending between a first end and a second end of the container. The divider is positioned between the first and second ends of the container. The first chamber may have an opening positioned on the first end of the container to allow contents from the first chamber to exit the container. Similarly, a second opening may be positioned on the second end of the container, opposite the first end of the container and the first opening thereof, in order to allow contents from the second chamber to exit the container.

The outer surrounding wall is preferably flexible to allow the container, and more particularly, either or both of the first and second chambers, to be squeezed in order to assist in removable of contents therefrom. The container is preferably formed of a material that retains its initial shape upon release of an applied squeezing force. The divider may be integrally formed with the outer surrounding wall, and may be flexible as well.

The container may be elongate, having a length between the upper end and the lower end that is greater than the width or diameter of the upper end or the lower end. In order to assist in gripping the container, such as when the container or a users hands may be wet, the outer surrounding wall of the dual chamber container may have a contoured shape to assist in gripping of the container. The dual chamber container may have a generally circular or ovular cross-section.

The openings of the container may be defined at least in part by a neck region of the outer surrounding wall. Removable caps may be provided for selectively closing the openings of the first and second chambers. The caps for the reclosable openings of the first and second chambers may include a planar outer surface that is effective to allow the container to be supported by the cap. For example, the container may be placed on a shelf, ledge or other horizontal surface with one of the caps facing downward. The neck regions of the container may be provided with an outwardly projecting rib, and the cap may include an inwardly projecting lip, thereby allowing the cap to snap on and off the neck when the inwardly projecting lip is shifted past the outwardly projecting rib.

A method is also provided for using a multiple chamber container having at least a first chamber separated from a second chamber by a divider. The method may include removing a cap from the opening of the first end of the container and removing contents from the first chamber of the container through the opening. The method may also include replacing the cap on the opening of the first end of the container. The method may also include removing the cap from the opening of the second end of the container, removing contents from the second chamber of the container through the opening, and then replacing the cap on the opening of the second end of the container.

The step of removing the first fluid from the first chamber of the container through the opening may include the step of arranging the container such that the opening is facing generally downward. The step of removing the second fluid from the second chamber of the container through the opening may also include the step of arranging the container such that the opening is facing generally downward.

The step of removing the first fluid from the first chamber of the container preferably includes the step of squeezing the flexible outer surrounding wall to decrease the volume of the first chamber. Similarly, the step of removing the second fluid from the second chamber of the container through the opening preferably includes the step of squeezing the flexible outer surrounding wall approximate the second chamber to decrease the volume of the second chamber to assist in removal of contents therefrom.

### BRIEF DESCRIPTION OF THE DRAWING

FIG. 1 is a side elevation view of a multiple chamber container in accordance with a first aspect;

FIG. 2 is a side elevation view a multiple chamber container in accordance with another aspect;

FIG. 3 is a cross-section view of the multiple chamber container of FIG. 2;

FIG. 4 is a detail view of a portion of the cross-section view of the multiple chamber container of FIG. 3;

FIG. 5 is a side elevation view a multiple chamber container in accordance with another aspect;

FIG. 6 is a side elevation view a multiple chamber container in accordance with another aspect;

FIG. 7 is a side elevation view a multiple chamber container in accordance with another aspect;

FIG. 8 is a side elevation view a multiple chamber container in accordance with another aspect having a pair of caps in the closed position;

FIG. 9 is a side elevation view the multiple chamber container of FIG. 8 with one of the caps in the closed position and the other of the caps in the open position; and

FIG. 10 is a detail side elevation view of a neck region of the multiple chamber container of FIG. 9 showing one of the caps in a closed position and removed from the neck region.

### DETAILED DESCRIPTION OF THE DRAWINGS

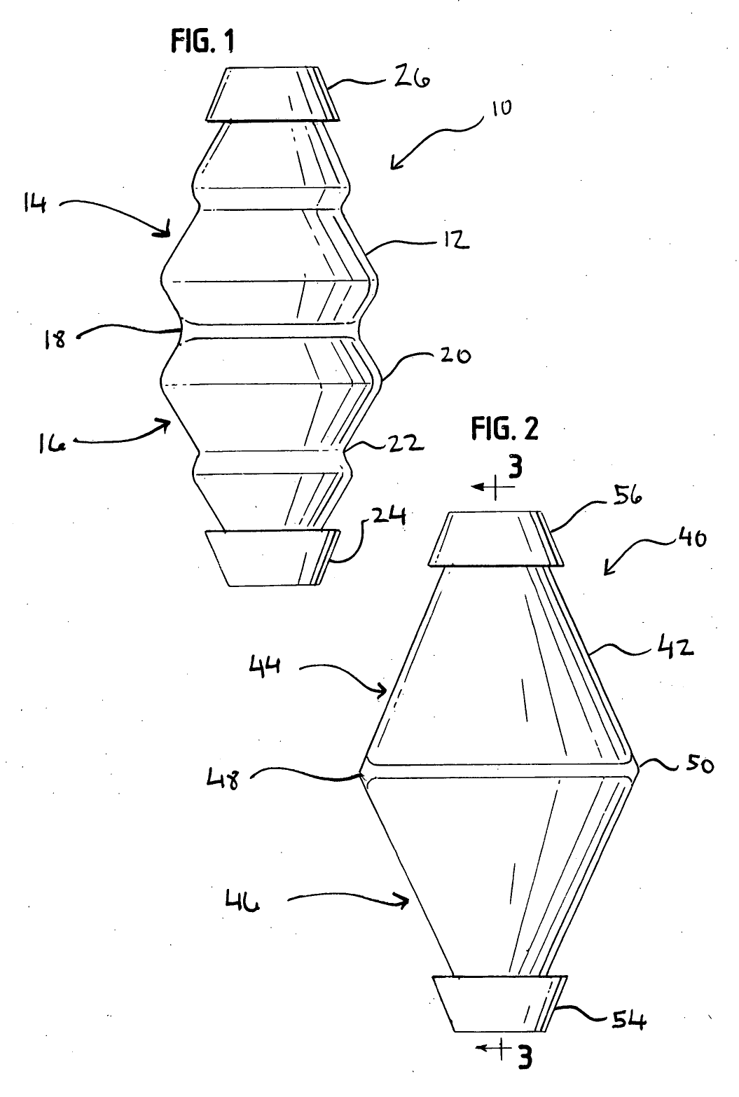

As shown in FIGS. 1-10, a multiple chamber container 10 or 40 is provided having first and second chambers 14 and 16 or 44 and 46 separated by an internal divider 18 or 48. The container is preferably formed of plastic or another flexible material that will retain its initial shape after being squeezed by the user. An opening 62 is provided on a first end of the container 40 and in communication with the first chamber 44 in order to allow contents to be removed therefrom. Another opening 64 is provided on a second end of the container 40, opposite the first end of the container 40, and in communication with the second chamber 46.

The container 10 of FIG. 1 comprises an outer surrounding wall 12. The first opening for the first chamber 14 is disposed on an end of the container 10 proximate one end of the outer surrounding wall 12, while the second opening for the second chamber 16 is disposed on an opposite end of the container 10 proximate an opposing end of the outer surrounding wall 12. The first and second chambers 14 and 16 are separated from each other by an internal divider 18 which extends within the outer surrounding wall 12 of the container 10 to form a sealed partition which prevents the contents of the first and second chambers from becoming intermixed. The divider wall 18 may be positioned near the mid-section of the outer surrounding wall 12 to partially define generally equally sized first and second chambers 14 and 16. Alternatively, the divider 18 wall may be positioned away from the mid-section of the outer surrounding wall 12 to partially define first and second chambers 14 and 16 having different volumes.

In one possible embodiment, the divider 18 is provided in the form of a thin wall that extends across the open space within surrounding wall 12, the divider 18 having an outer periphery that extends to the inner surface of the surrounding wall 12. In another form, the outer surrounding wall circumscribes a space having a cross section which converges near the mid-section of the surrounding wall 12 to form a narrow section. In this embodiment, the divider is located at the narrow section, and can be provided, for example, as a seam which seals opposing faces of the inner surface of the surrounding wall 12 together to form a sealed partition between the first and second chambers. In such an embodiment, the seam may also serve as a hinge allowing the two separated portions of the container to be positioned adjacent one another with the first and second openings facing the same direction.

The container 40 of FIGS. 2-4 is similar to the container 10 of FIG. 1, except for its external shape, as will be described in greater detail. The container 40 comprises an outer surrounding wall 42. The first opening 62 for the first chamber 44 is disposed on an end of the container 40 proximate one end of the outer surrounding wall 42, while the second opening 64 for the second chamber 46 is disposed on an opposite end of the container 40 proximate an opposing end of the outer surrounding wall 42. The first and second chambers 44 and 46 are separated from each other by an internal divider 48. As with the container 10 of FIG. 1, the divider 48 may be positioned near the mid-section of the outer surrounding wall 42 to partially define generally equally sized first and second chambers 44 and 46. Alternatively, the divider 48 may be positioned away from the mid-section of the outer surrounding wall 42 to partially define first and second chambers 44 and 46 having different internal volumes 66 and 68.

The container 10 or 40 may have a contoured outer shape to assist in gripping the container 10 or 40. For instance, when the container 10 or 40 is used in a wet environment, such as a shower, projections 20 or 50 can provide gripping surfaces to assist in gripping the container 10 or 40, as illustrated in FIGS. 1-3. The projections 20 may be spaced by alternating depressions 22 to further assist in providing gripping surfaces for gripping the container 10, as shown in FIG. 1.

The first and second ends of the container 10 or 40 each have a neck region 58 and 60 defined by the outer surrounding wall 42. The neck regions 58 and 60 define the openings 64 and 62 that allows the contents of the first and second chambers 44 and 46 to be removed from the container 40. The neck regions 58 and 60 are each configured to receive a removable cap 54 or 56. When the cap 54 or 56 is placed on one of the neck regions 58 or 60, contents are generally prevented from exiting the interior 66 or 68 corresponding chamber 46 or 44 through the respective opening 62 or 64. When the cap 54 or 56 is removed from the neck region 58 or 60, the contents of the corresponding chamber 46 or 44 can exit through the opening 62 or 64. The removable caps 54 or 56 may include a planar surface 70 that allows for the container 40 to be supported in a vertical orientation by resting on the cap 54 or 56.

The removable caps may come in a variety of different suitable configurations. For example, the removable caps may be attached to the container, such as by tethers between the caps a ring surrounding each of the neck regions. The removable caps may be permanently hinged to the neck regions of the container.

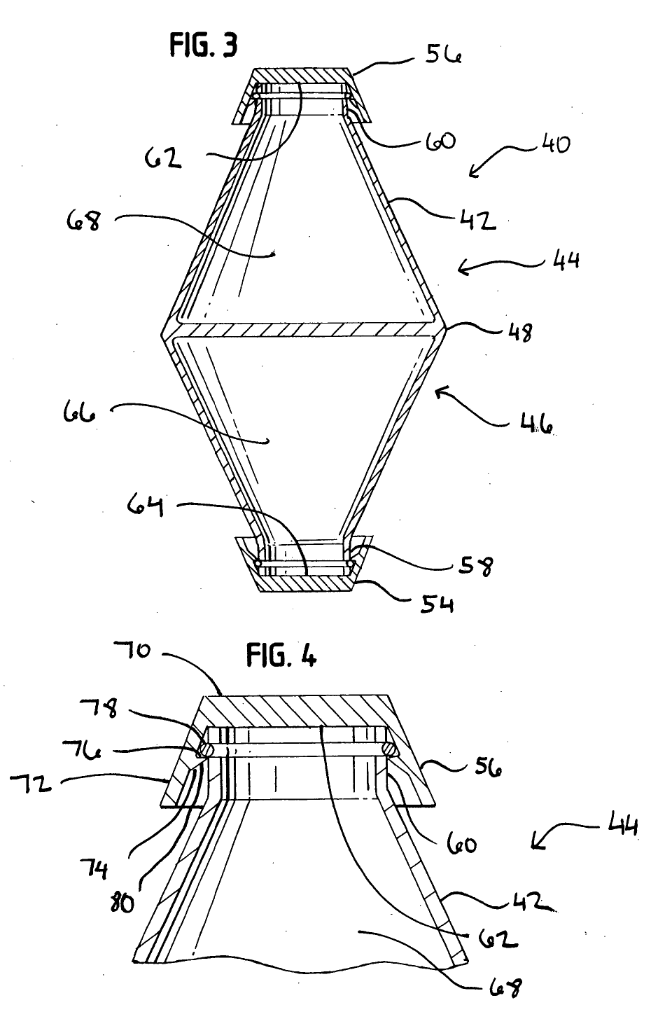

In another alternative, the removable caps 54 and 56, such illustrated in FIGS. 3 and 4, are able to snap onto and off of the neck regions 58 and 60 of the container 40. The planar surface 70 of the cap 56 may have a depending skirt 72 that at least partially surrounds the neck region 60 when placed on the container 40. Within the depending skirt 72 may be one or more inwardly-facing projections 80 having a sloped edge 74 on one side and a ledge 76 on the other side. The neck region 60 may include an outwardly projecting rib 78. When the cap 56 is placed over the neck region 60, the rib 78 will ride up the slope 74 of the projection 80, with either or both of the rib 78 and the projection 80 deflecting to allow the rib 78 to pass over the slope 74. Once the rib 78 has passed over the inwardly projecting end of the slope 74, the rib 78 is then supported on the ledge 76 which resists removal of the cap 56 from the neck region 60 of the container 40.

The containers 10 and 40 may come in a variety of different sizes, shapes and configurations. For example, the containers 10 and 40 may have a generally circular or ovular cross-section. The containers 10 and 40 may also have a larger cross-section proximate their midsections than proximate the neck regions 58 and 60, as illustrated in FIGS. 1-3. The container 10 or 40 may have smooth, contoured internal surfaces to simplify removal of contents from the first and second chambers 14 and 16 or 44 and 46. For example, the portions of the outer surrounding wall 12 or 42 proximate the neck regions 58 and 60 may taper with a decreasing cross-section toward the neck regions 58 and 60 to funnel contents toward the neck regions 58 and 60.

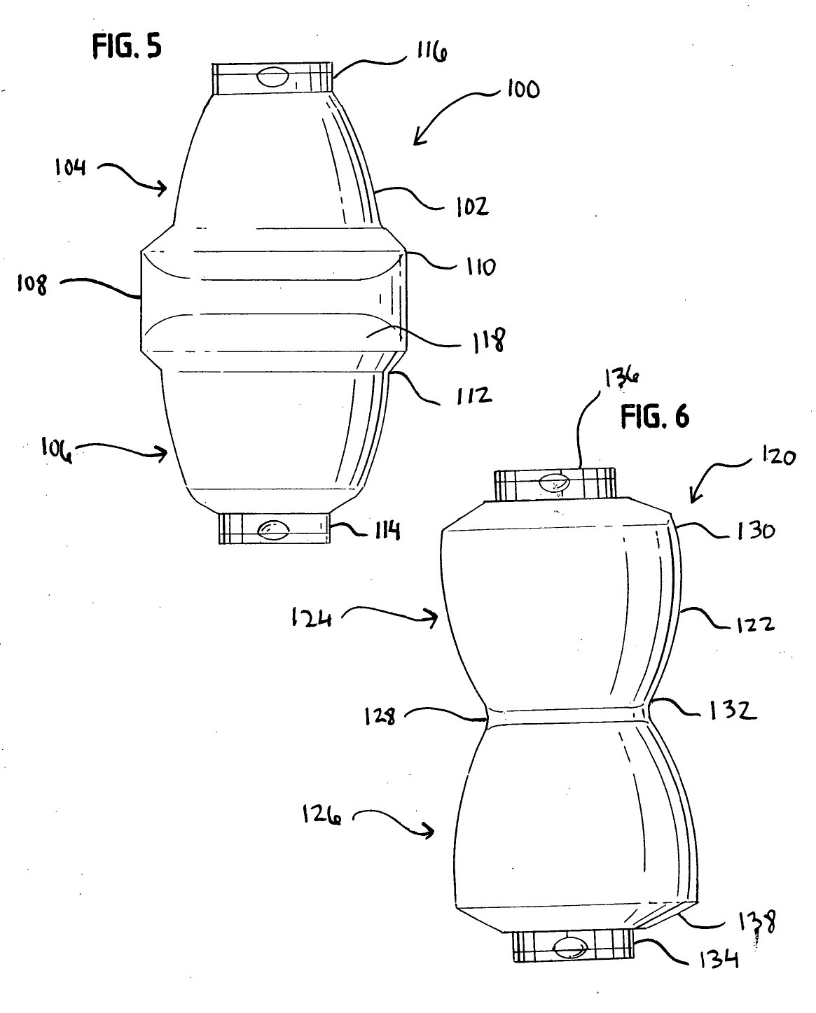

The container 100 of FIG. 5 is similar to the containers discussed above, except for its external shape and caps, as will be described in greater detail. The container 100 comprises an outer surrounding wall 102. A first opening for the first chamber 104 is disposed on an end of the container 100 proximate one end of the outer surrounding wall 102, while the second opening for the second chamber 106 is disposed on an opposite end of the container 100 proximate an opposing end of the outer surrounding wall 102. The first and second chambers 104 and 106 are separated from each other by an internal divider 108 which extends across the open space within the outer surrounding wall 102 and is positioned near the midsection of the container to partially define generally equally sized first and second chambers 104 and 106. The midsection 110 of the container 100 is enlarged as compared to the ends, and there is a tapered area 112 between the enlarged midsection 110 and the ends of the container to assist in gripping of the container. A pair of caps 116 and 114 are used to close the openings at the ends of the container 100. The caps 114 and 116 each have a lid, as will be discussed in greater detail below.

The container 120 of FIG. 6 is similar to the containers discussed above, except for its external shape and caps, as will be described in greater detail. The container 120 comprises an outer surrounding wall 122. A first opening for the first chamber 124 is disposed on an end of the container 120 proximate one end of the outer surrounding wall 122, while the second opening for the second chamber 126 is disposed on an opposite end of the container 120 proximate an opposing end of the outer surrounding wall 122. The first and second chambers 124 and 126 are separated from each other by an internal divider 128 which extends across the open space within the outer surrounding wall 122 and is positioned near the midsection of the container 120 to partially define generally equally sized first and second chambers 124 and 126. The midsection 132 of the container 120 is smaller in diameter or profile as compared to the ends 130, and there is a tapered area 138 between the ends of the container 130 and the neck region. The smaller midsection 132 of the container, along with the contours of the end sections on either side of the divider 128, provide a feature to assist in gripping of the container 120. A pair of caps 134 and 136 are used to close the openings at the ends of the container 120. The caps 134 and 136 each have a lid, as will be discussed in greater detail below.

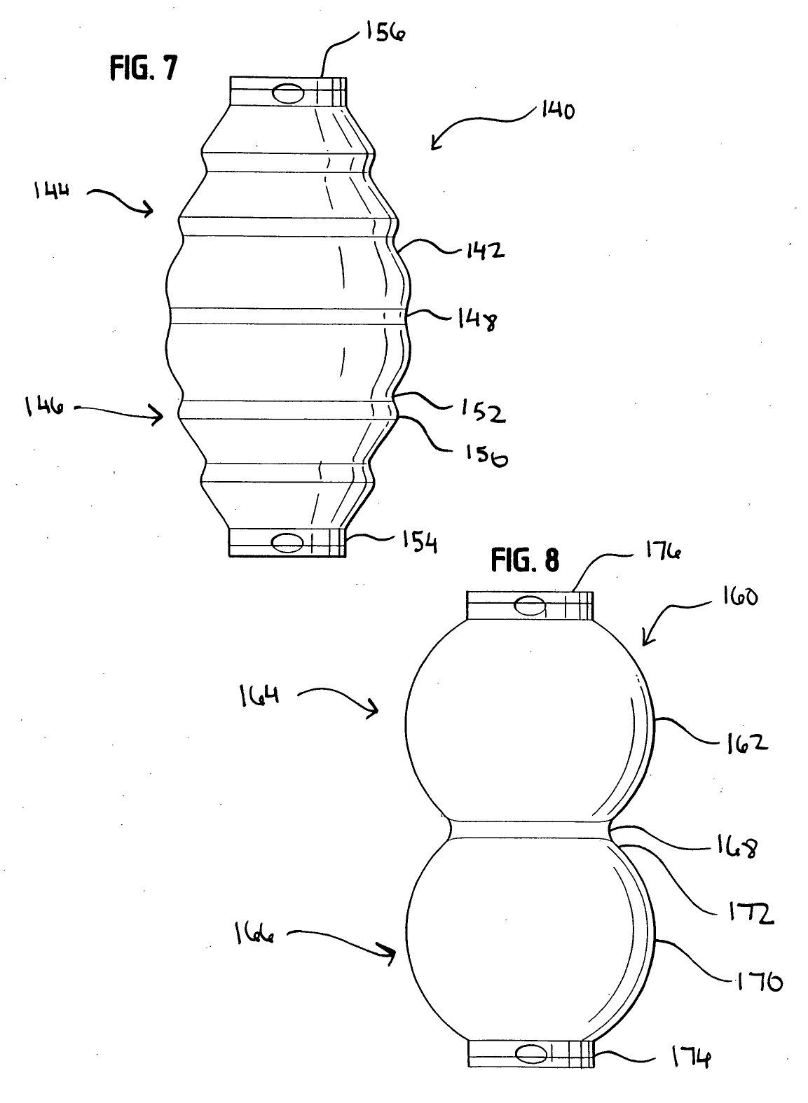

The container 140 of FIG. 7 is similar to the containers discussed above, except for its external shape and caps, as will be described in greater detail. The container 140 comprises an outer surrounding wall 142. A first opening for the first chamber 144 is disposed on an end of the container 140 proximate one end of the outer surrounding wall 142, while the second opening for the second chamber 146 is disposed on an opposite end of the container 140 proximate an opposing end of the outer surrounding wall 142. The first and second chambers 144 and 146 are separated from each other by an internal divider 148 which extends across the open space within the outer surrounding wall 142 and is positioned near the midsection of the container 140 to partially define generally equally sized first and second chambers 144 and 146. The midsection of the container 140 is generally larger as compared to the ends, and tapers toward the ends in a series of ridges 150 and depressions 152, which provide surfaces for gripping. A pair of caps 154 and 156 are used to close the openings at the ends of the container 140.

The container 160 of FIGS. 8-10 is similar to the containers discussed above, except for its external shape and caps, as will be described in greater detail. The container 160 comprises an outer surrounding wall 162. A first opening for the first chamber 164 is disposed on an end of the container 160 proximate one end of the outer surrounding wall 162, while the second opening for the second chamber 166 is disposed on an opposite end of the container 160 proximate an opposing end of the outer surrounding wall 162. The first and second chambers 164 and 166 are separated from each other by an internal divider 168 which extends across the open space within the outer surrounding wall 162 and is positioned near the midsection of the container 160 to partially define generally equally sized first and second chambers 164 and 166.

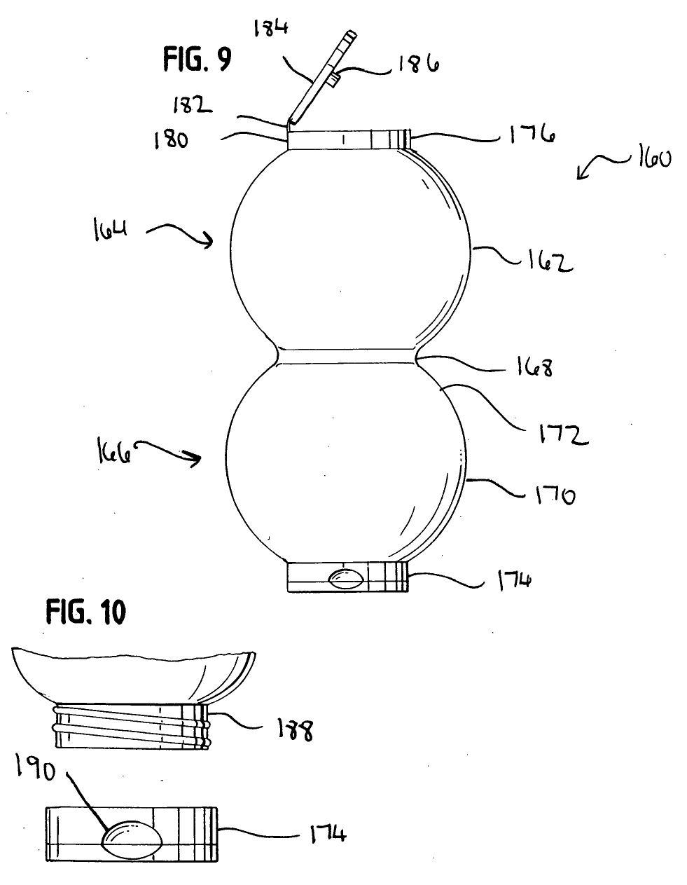

The first and second chambers 164 and 166 are generally spherical in appearance, as illustrated in FIGS. 8 and 9. The spheres are each generally larger proximate their midsections 170 as compared to their ends 172. The decreasing size of the spheres proximate the midsection of the container 160 provides a gripping region.

Turning now to the details of the caps illustrated in FIGS. 5-10, and with reference to FIGS. 8-10, the caps 174 and 176 each comprise a base section 180 and a lid 184, as illustrated in FIG. 9. The lid 184 is hinged to the base section via a flexible hinge 182 in order to allow the lid to be selectively shifted from an open position to a closed position. In the closed position, a plug 186 depending from the lid 184 may mate with the perimeter of an aperture formed in the end of the container to generally seal the aperture to prevent removal of contents via the aperture. The base 180 may have an internal thread that mates with a thread-formed on the neck region 188 of the container, as illustrated in FIG. 10. A depression 190 may be formed in one or both of the base and lid 180 and 184 to provide a gripping surface for opening the lid. However, other types of caps may be used.

To use the container 10 or 40, the container 10 or 40 may be gripped and the cap 54 or 56 removed from one of the openings 62 or 64 to gain access to the interior 66 or 68 of the respective chamber 44 or 46. The container 40 can then be placed back on a shelf or in storage, or the container 40 may be inverted and the other cap 54 or 56 removed (or, in the case of a cap having a lid, the lid opened) to gain access to the contents of the other chamber 44 or 46. The containers of FIGS. 1-10 are used in similar manners, with the exception of the operation of the snap caps as compared to the caps having lids. Accordingly, the discussion of the operation of the containers 10 and 40 is generally applicable to the operation of containers 100, 120, 140 and 160.

The multiple chamber containers are suitable for a variety of contents. For example, in one aspect the container may be used for holding shampoo in the first chamber and conditioner in the second chamber. Pairing the two different but commonly used together contents in a single container advantageously allows for the combined storage of two separate fluids in a single container.

The outer surrounding walls of the container may be flexible, along with the divider wall. Thus, flexing of the outer surrounding wall defining a portion of the first chamber or the second chamber will decrease the volume of the chamber or and assist in removing contents thereof. The outer surrounding wall may be clear or translucent, thereby allowing visual identification of the contents of the first and second chambers to allow for distinguishment thereof. The use of separately colored contents within the first and second chambers can assist in the visual distinguishment of the chamber contents. In addition, a translucent or opaque outer surrounding wall can enable viewing of the level of the contents within the chamber.

The container can be made using any suitable manufacturing techniques, such as blow molding or injection molding. The containers may be produced in a variety of sizes, such as small sizes for travel or larger sizes for home use. Examples of product pairs that may be conveniently provided in the dual chamber container include mustard/catsup, oil/vinegar, shampoo/conditioner, soap/hand lotion, etc. In general, the dual chamber container is well suited for storage and delivery of any pair of products that flow by force of gravity and/or upon application of a constricting force on the container.

As will be appreciated, multiple chamber containers and methods of using multiple chamber containers are disclosed herein. However, the inventions are not limited to the preferred embodiments described hereinabove or to any particular embodiments. For example, the multiple chamber container may have three or more separate chambers, each with an opening on a different side of the container.

1. A multiple chamber container, the container comprising:
a flexible, outer surrounding wall extending between an upper end and a lower end of the container;
a divider between the upper end and the lower end of the container, the divider separating a first chamber from a second chamber;
a first opening positioned on the upper end of the container in communication with the first chamber; and
a second opening positioned on the lower end of the container and in communication with the second chamber.

2. A multiple chamber container in accordance with claim 1, wherein the first and second openings are selectively reclosable.

3. A multiple chamber container in accordance with claim 1, wherein the first and second openings are selectively reclosable with removable caps.

4. A multiple chamber container in accordance with claim 1, wherein the outer surrounding wall has one or more protrusions effective to provide gripping surfaces of the container.

5. A multiple chamber container in accordance with claim 1, wherein the container is elongate, having a length between the upper end and the lower end being greater than the width of the upper end or the lower end.

6. A multiple chamber container in accordance with claim 3, wherein at least one of the first and second caps has an outer surface with a generally planar portion effective to allow the container to be supported by the cap.

7. A multiple chamber container in accordance with claim 2, wherein at least one of the first and second reclosable openings is defined by a neck region of the outer surrounding wall.

8. A multiple chamber container in accordance with claim 7, wherein a portion of the outer surrounding wall proximate the neck region tapers with a decreasing cross-section toward the neck region.

9. A multiple chamber container in accordance with claim 7, wherein the cap is one of able to snap on and off the neck to allow access to the interior of the container and able to be opened and closed to allow access to the interior of the container.

10. A multiple chamber container in accordance with claim 9, wherein the neck region includes an outwardly projecting rib and the cap includes an inwardly projecting lip, the neck rib and the cap lip being sized to cooperate to selectively permit engagement of the neck and the cap.

11. A multiple chamber container in accordance with claim 7, wherein the neck region includes a thread and the cap includes a mating thread to permit the cap to be secured to the neck region of the container.

12. A multiple chamber container in accordance with claim 1, wherein the divider is integral with the outer surrounding wall.

13. A multiple chamber container in accordance with claim 12, wherein the divider is flexible.

14. A multiple chamber container in accordance with claim 1, wherein the container has a generally circular cross-section.

15. A multiple chamber container in accordance with claim 1, wherein the container has a generally ovular cross-section.

16. A multiple chamber container in accordance with claim 1, wherein the cross-section of the container proximate the divider is larger than the cross-section of the container proximate one of the first and second ends of the container.

17. A multiple chamber container in accordance with claim 15, wherein the cross-section of the container proximate the divider is smaller than the cross-section of the container proximate both of the first and second ends of the container.

18. A method of using a multiple chamber container, the multiple chamber container having a flexible outer surrounding wall extending between a first end of the container and an opposing second end of the container, a divider positioned within the outer surrounding wall and spaced from the first and second ends of the container to define first and second chambers, the first chamber containing a first fluid and the second chamber containing a second fluid, the first and second ends of the container each having an opening selectively reclosable with a cap, the method comprising:
removing the cap from the opening of the first end of the container; 0
removing the first fluid from the first chamber of the container through the opening;
replacing the cap on the opening of the first end of the container;
removing the cap from the opening of the second end of the container;
removing the second fluid from the second chamber of the container through the opening; and
replacing the cap on the opening of the second end of the container.

19. The method of using the multiple chamber container of clam 18, wherein the step of removing the first fluid from the first chamber of the container through the opening includes the step of arranging the container such that the opening is facing generally downward.

20. The method of using the multiple chamber container of clam 19, wherein the step of removing the second fluid from the second chamber of the container through the opening includes the step of arranging the container such that the opening is facing generally downward.

21. The method of using the multiple chamber container of clam 20, wherein the step of removing the first fluid from the first chamber of the container through the opening includes the step of squeezing the flexible outer surrounding wall to decrease the volume of the first chamber.

22. The method of using the multiple chamber container of claim 21, wherein the step of removing the second fluid from the second chamber of the container through the opening includes the step of squeezing the flexible outer surrounding wall to decrease the volume of the second chamber.
